(19) United States
(12) Patent Application Publication
(10) Pub. No.: US 2006/0277141 A1
(43) Pub. Date: Dec. 7, 2006

(54) Method and system for accelerated collateral review and analysis

(76) Inventor: Robert Palmer, Irvine, CA (US)

Correspondence Address: ARENT FOX PLLC, 1050 CONNECTICUT AVENUE, N.W., SUITE 400, WASHINGTON, DC, 20036, US

(21) Appl. No.: 11/443,108

(22) Filed: May 31, 2006

Related U.S. Application Data
(60) Provisional application No. 60/686,410, filed on Jun. 2, 2005.

(51) Int. Cl. G06Q 40/00

(52) U.S. Cl. 705/38

(57) ABSTRACT

A method and system for automated review and analysis of appraisal reports, including receiving and identifying an appraisal report. After identifying the appraisal report, relevant data and/or information contained therein is identified and extracted. The extracted data and/or information are then normalized for subsequent evaluation. Thereafter, the normalized data and/or information is evaluated to determine, for example, whether the appraisal report complies with generally accepted appraisal practices and whether the appraised property represents a low, moderate, high, or very high risk. The method and system also generates an output relating to the appraisal report evaluation.

### CROSS-REFERENCE TO RELATED APPLICATIONS

This application claims the benefit of U.S. Provisional Application No. 60/686,410, filed Jun. 2, 2005, which is incorporated herein by reference in its entirety.

### BACKGROUND OF THE INVENTION

1. Field of the Invention

The present invention relates to a method and system for automatically reviewing and analyzing appraisal data and reports, particularly appraisal reports for real property, such as residential or commercial real property. However, the present invention is applicable to any form of property for which an appraisal has been performed, such as jewelry, art, and automobiles, among others. For the purposes of this disclosure, the present invention is described in relation to appraisal reports for residential real property used in the mortgage industry.

2. Background of the Technology

One problem in the mortgage industry is that all residential appraisal reports go through a manual, labor-intensive process, from their initiation, until finally received by underwriters or loan processors, who continue to perform manual review and analysis of the documents in order to make a loan decision. While much of the mortgage industry has experienced automation, the collateral and appraisal portions of the industry have not. The mortgage industry uses several appraisal forms, all of which are somewhat standardized. The collateral/appraisal report data is thus presented in a semi-standardized format throughout the industry. However, among other things, the number and differences among forms, as well as the typical ways in which such forms are submitted, have previously prevented automation.

Another problem in the mortgage industry is that, currently, collateral/appraisal review and analysis is a slow and labor-intensive process, as every aspect of the property subject to appraisal must be reviewed by a human being. These manual and labor-intensive aspects of the current collateral/appraisal processes exist despite the fact that many aspects of a collateral/appraisal report are standardized and generally the same data is presented in a similar place on each form.

In order to make a mortgage loan decision, a lender typically uses three primary loan documents: (1) the loan application (alternatively referred to herein as the “1003 loan application” or the “1003application”), which contains information about borrowers; (2) a credit report; and (3) an appraisal report. On a case-by-case basis, lenders may require potential borrowers to submit numerous additional supplemental documents, depending on the loan type, such as W2 forms, pay stubs, and the like. The core of most mortgage loans, however, is based on the three primary documents. It is known in the art that two of these three primary documents, the 1003 application and the credit report may be automated and processed to grant credit approval to a borrower almost instantaneously. For example, a credit report may be evaluated in a matter of minutes, and a 1003 application may be input into a lender's Internet web interface or sent to the lender via a software application, resulting in an almost instantaneous credit decision. The process involves certain conditions and additional verifications but, for the most part, it becomes clear whether a given borrower is eligible for approval for the 1003 application and the credit report almost instantaneously.

One difficult issue to analyze and evaluate—and therefore to automate—is whether the collateral, or the basis for the loan (i.e., the tangible asset on which the loan is based), warrants the grant of the loan (a process interchangeably referred to herein as “appraisal”). At present, borrowers may receive almost instant approval on their credit reports and 1003 applications, while the evaluation of the appraisal report analysis is usually not completed until days later. This delay in evaluating the appraisal report is due, at least in part, to the time necessary to have a qualified person examine the report. Although such a manual review may require, for example, 10 to 25 minutes, the total turn-around time, i.e., the duration between submitting the appraisal report to the qualified person and the subsequent transmittal of evaluation results, may be several days. Consequently, the loan process is subject to a significant delay due to the time required to manually review the appraisal report.

Furthermore, lenders have a number of transactional costs and expenses associated with the loan approval process, and specifically with the appraisal report evaluation and analysis, such as costs associated with preparation of appraisal document packages, overnight delivery expenses, costs and fees associated with personnel to review and analyze the appraisal, and other expenses related to the analysis of the appraisal report that are incurred before the lender is able to make an actual decision on the loan. Among other things, there is a general need, therefore, for methods and systems that permit automation of the collateral/appraisal report review and analysis processes. There is a further need for providing such methods and systems that allow evaluation and analysis of the primary loan documents, on which lenders base their decision, at the very beginning of or otherwise early in the loan approval process. Also, there is a need for providing such methods and systems that allow for an accelerated review and analysis of the collateral/appraisal data, compared to traditional methods and systems. Further, there is a need for methods and systems for automated collateral/appraisal review and analysis processes that are easy to use, while at the same time preserving the integrity of all relevant data. There is yet an additional need to provide such methods and systems that reduce the transactional costs associated with the loan approval process in a manner that decreases the cost of operation over traditional methods and systems.

### SUMMARY OF THE INVENTION

The present invention solves one or more of the above identified needs, as well as others, by providing a network-based (e.g., Internet-based) automated method and system for appraisal report review and analysis. The present invention provides a method and system for appraisal reports review and analysis that are fast and easy to use, while at the same time preserve the integrity of all relevant data. Further, the present invention provides a method and system for appraisal review and analysis that reduce transactional costs associated with the review and analysis of the appraisal reports.

Generally, obtaining a residential real property (interchangeably referred to hereinafter as “home” or “subject property”) mortgage, including purchase mortgages and home equity mortgages, for example, involves the use of three primary documents: (1) 1003 application that contains information about borrowers; (2) a credit report; and (3) an appraisal report of the subject property. Presently, review of the 1003 application and credit report are accelerated due to automation of the review process, leaving only the appraisal report to be reviewed manually.

The method and system for appraisal report review and analysis of the present invention (interchangeably referred to herein as “collateral review and analysis system”) determines the type of appraisal form that has been submitted. Generally, there are only a few types of appraisal forms used almost exclusively in the mortgage business relating to residential real property. Therefore, the present invention identifies specifically which type of appraisal form has been used. However, the present invention is not limited to use with any particular form but is capable of analyzing any form submitted. Once the appraisal form is identified, the collateral review and analysis system parses through the information contained in the appraisal document and identifies the relevant information required and captures the relevant information. In one embodiment, optical character recognition (“OCR”) techniques are used to identify and capture the necessary information contained in the appraisal report. The captured information is stored in a database or other data repository and is subjected to data normalization so that the information can be efficiently analyzed. The normalized data is stored in the data repository. On occasion, some data may not be recognized by the system of the present invention and, consequently, may be designated for administrative review, such as by a person, to identify the unrecognized data.

The collateral review and analysis system evaluates the appraisal report using the extracted and normalized data to determine whether, for example, the appraisal report was fully completed, the appraisal data is consistent throughout the appraisal report, and the appraisal complies with generally accepted appraisal practices. According to one embodiment, if the appraisal report does not conform to generally accepted appraisal practices, the present invention identifies which portion(s) of the appraisal report do not comply and, optionally, the reasons those portion(s) do not comply. For example, the present invention includes logic that may be customizable to trigger a result if an attribute of an appraised property exceeds or is otherwise dissimilar from a corresponding attribute of one or more properties used for comparison. According to a further embodiment of the present invention, a report including the evaluation results is generated and is subsequently transmitted to the user, customer, or some other designated party.

Additional aspects, advantages, and novel features of the invention will be better understood as set forth in the following description and accompanying drawings and will also become apparent to those skilled in the art upon examination of the following or upon learning by practice of the invention.

### BRIEF DESCRIPTION OF THE FIGURES

The features of the invention will be more readily understood with reference to the following description and the attached drawings, wherein:

FIG. 1 presents an example flow diagram of functions performed in accordance with an embodiment of the present invention;

FIG. 2 presents an exemplary flow diagram of a normalization process according to an embodiment of the present invention;

FIG. 3 illustrates a hierarchical user structure of an embodiment of the present invention;

FIG. 4 illustrates an example GUI screen for defining a single-line guideline rule according to an embodiment of the present invention;

FIG. 5 illustrates an example GUI screen for defining a multiple-line guideline rule according to an embodiment of the present invention;

FIG. 6 presents an exemplary system diagram of various hardware components and other features, for use in accordance with an embodiment of the present invention; and

FIG. 7 is a block diagram of various exemplary system components, in accordance with an embodiment of the present invention;

### DETAILED DESCRIPTION

The present invention relates to a method and system for appraisal report review and analysis. Particularly, the present invention relates to a method and system for analyzing an appraisal report for residential real property, such as an appraisal report accompanying a load application. However, the scope of the present invention is not so limited and may also be applied to commercial real property. Moreover, the present invention is applicable to any type of property subject to appraisal and completed on standardized forms, such as, for example only, automobiles, jewelry, artwork, among other types of property. However, for the purposes of an exemplary explanation and description, the present invention will be described with respect to residential real property.

Corresponding features of different embodiments described herein are identified with the same reference numbers.

When a prospective home buyer (referred to hereinafter as “home buyer” or “buyer”) seeks to buy a home, the buyer may seek to obtain a home mortgage via one of two different paths. One path is a wholesale path, in which the buyer approaches a mortgage broker to obtain a home mortgage loan. The mortgage broker requests that the buyer complete the necessary documents, i.e., the 1003 application, and then orders the buyer's credit report and an appraisal report for the subject property. The mortgage broker may “shop” the mortgage loan to multiple lenders in an effort to obtain the best mortgage terms for the buyer, by sending each potential lender copies of the buyer's 1003 application, the credit report, and appraisal report, as well as other documents requested by the lender, such as W2 documents, divorce decrees, alimony decrees, and court settlement documents.

A second path is the retail path, in which the buyer deals directly with a lender, such as a bank. Normally, the buyer discusses the mortgage loan with a bank representative, who similarly requests that the buyer complete a 1003 application. The bank representative also orders the buyer's credit report and an appraisal report for the subject property.

When ordering an appraisal report during the course of either the wholesale path or the retail path, the mortgage broker or the bank's representative, respectively, may contact an appraiser and request an appraisal report on the subject property. The appraiser may prepare an appraisal by, for example, completing one of the appraisal reports used in the home mortgage loan industry, such as the Uniform Residential Appraisal Report (“URAR”), the Individual Condominium Unit Appraisal Report (“CONDO”), and the Exterior Only Residential Appraisal Report (“2055”). During the appraisal process, the Appraiser compares the subject property against other comparable residential properties (interchangeably referred to herein as “comparable property,” “comparable,” or “comp”). Usually, the Appraiser selects between three and six comps to determine an appraisal value of the subject property. However, the Appraiser may use more or fewer comps. Similarly, the present invention is operable with any number of comps.

For the purposes of illustration only, the subject property may be a 3,000 square foot, three-bedroom, two-bathroom home. The Appraiser may select a number of comps that “bracket” the subject property. For example, the Appraiser may select comparable properties, each with a known sale price, having characteristics that are as closely aligned with the characteristics of the subject property as possible, e.g., the same number of rooms and bathrooms and similarly geographically situated. Some of the comps may not be entirely identical, e.g., may be slightly larger or slightly smaller than the subject property. The Appraiser may then compare the individual characteristics of each comp to the subject property and make adjustments accordingly. For example, the subject property may have a swimming pool, whereas one comp may not. Consequently, the Appraiser will adjust the selling price of the comp by adding a value corresponding to the swimming pool, e.g., $10,000. Alternatively, one comp may have a three-car garage, while the subject property only has a two-car garage. Therefore, the Appraiser may indicate a negative adjustment to the selling price of the comp corresponding to the difference between a two-car garage and a three-car garage, e.g., $5,000. The adjustment amounts are determined by comparing sales with the same attributes but for one, then the difference between the two sale's sale prices is the identified market value of that attribute; this is known in the industry as “paired sales analysis”.

Once the Appraiser has completed the Appraisal report, the Appraiser may submit the Appraisal report to the requesting party, e.g., the mortgage broker or bank representative. Thereafter, the mortgage broker or the bank representative may transmit the appraisal report, either directly or indirectly, to the collateral review and analysis system of the present invention.

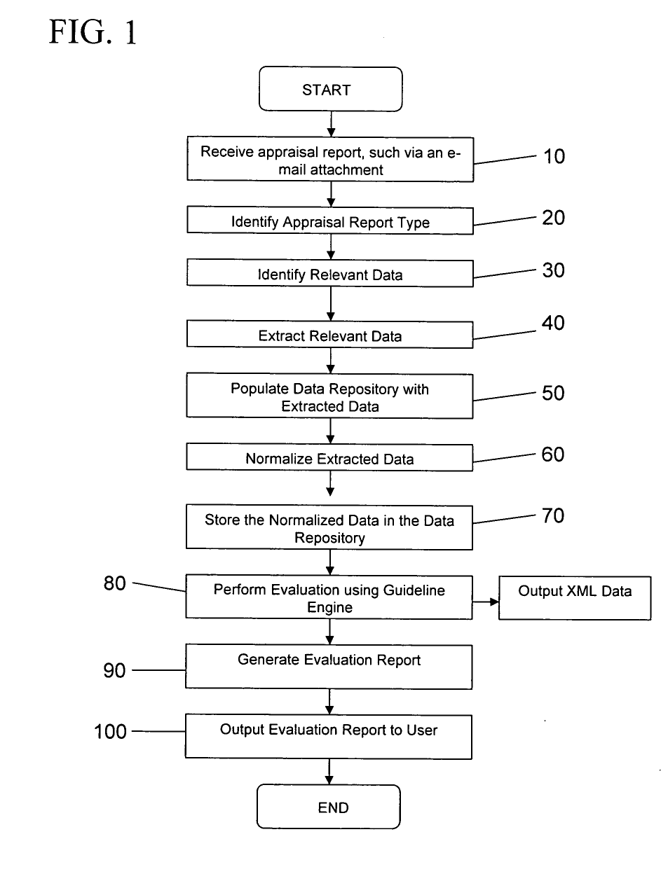

The method accordingly to one embodiment of the present invention is illustrated in FIG. 1. One or more appraisal reports 10 is received, and the type of appraisal report submitted 20 is identified. Portions of the appraisal report containing information required for the review and analysis process are identified, as described below. The required appraisal portions may be only select parts of the appraisal or, conversely, the required appraisal portions may be all of the data and/or information included in the appraisal report. Once identified 30, the required data and information is extracted 40 and stored 50. Thereafter, the extracted data is normalized 60, and stored in data repository 70, such as an electronic database.

Thereafter, the extracted data and information 80 is evaluated using a plurality of guideline rules (interchangeably referred to hereinafter as “guideline engine”), which are sophisticated customizable rules for analyzing the data and/or otherwise identifying whether one or more other predetermined events have occurred. For example, the evaluation may proceed in two stages. A first stage of the evaluation, referred to as a static check, may include determining whether the appraisal report was fully completed and determining the applicability or existence of certain information, such as whether check boxes on the appraisal report were checked. A second stage may include a review of the Appraiser's analysis of the subject property. That is, the second stage may include determining whether the appraisal of the subject property was performed according to generally accepted appraisal practices. In addition, the second stage of the evaluation may include identifying any potential problems with the subject property that may result in rejection of a mortgage loan or the grant of a mortgage loan on a conditional basis. Once the evaluation is complete, a report containing results of the appraisal analysis is generated 90 and output 100.

The appraisal report may be transmitted to the collateral review and analysis system in numerous formats. In one embodiment, the appraisal report is in the form of an Adobe® Acrobat® Portable Document Format (“PDF”) made by Adobe Systems Incorporated of 345 Park Avenue, San Jose, Calif. 95110-2704. However, it is within the scope of the present invention that the Appraisal report be in any document or image format, such as Microsoft® Word® format made by Microsoft Corporation of One Microsoft Way, Redmond, Wash. 98052-6399, Corel® WordPerfect® format made by Corel Corporation of 7905 Fuller Road, Eden Prairie, Minn. 55344, or any other document or electronic image format. Thus, the present invention is not limited to any particular document format but, rather, is usable with any document format. For exemplary purposes only, the document format of the appraisal report will be referred to as a PDF document for the remainder of the description of the present invention.

Further, the appraisal report may be transmitted in any number of ways. For example, the appraisal form may be scanned, electronically stored, and transmitted. Alternately, the Appraisal report may be created directly in PDF format and transmitted. The appraisal report may be transmitted via telephone lines as part of a facsimile, for example, or via the Internet by uploading the appraisal report directly to a website or as an attachment to an e-mail.

In the wholesale mortgage context, the appraisal report may be submitted in numerous ways. For example, the mortgage broker may submit the appraisal report along with the 1003 application and the buyer's credit report to a prospective lender. The lender may then submit the appraisal report to the collateral review an analysis system of the present invention. Alternatively, the mortgage broker may transmit the appraisal report directly to the collateral review and analysis system, e.g., by directly transmitting the appraisal report to a website or sending the appraisal report as an attachment in an e-mail. In the retail context, a representative of the bank may transmit the appraisal report to the collateral review and analysis system of the present invention via facsimile, website upload, or e-mail attachment.

Once the appraisal report has been transmitted and received, the type of appraisal report, e.g., URAR, CONDO, or 2055 report, is identified 20. For example, according to one embodiment of the present invention, the appraisal report is scanned and the type of form is determined by recognizing specific characteristics unique to each type of appraisal report. In this embodiment, the collateral review and analysis system identifies the appraisal report type by optical character recognition (“OCR”) and optical mark recognition (“OMR”) techniques. The system may optically scan the entire appraisal report and may identify and compare particular characteristics or features of the report to known features and characteristics of the types of reports used in the home mortgage loan industry.

Once the type of appraisal report submitted is identified 30, the appraisal form is searched to find portions of the appraisal report containing necessary information used in the subsequent analysis. As explained above, the relevant portions may be only a part of the appraisal report or the entire appraisal report. Moreover, once the type of appraisal report is identified 30, all necessary portions of the appraisal report may be identified, regardless of the manner, in which the appraisal report was submitted. Thus, all necessary information is identified even if the pages of the appraisal report were not in sequential order when transmitted or if additional pages were included that were unrelated to the appraisal report, for example.

Once identified 30, the necessary information and data are extracted 40, and specific appraisal report data fields are stored in the data repository 50, such as by being associated with specific database (or other data repository of data) fields. Thereafter, the extracted information and data are subjected to data normalization 60. Data normalization is a process in which data contained in the appraisal report, such as mathematicalΩvalues, customary abbreviations for common terms or phrases, descriptive words, or any other information, are identified and translated into a uniform term or identifier to permit subsequent comparison with other normalized data, for example.

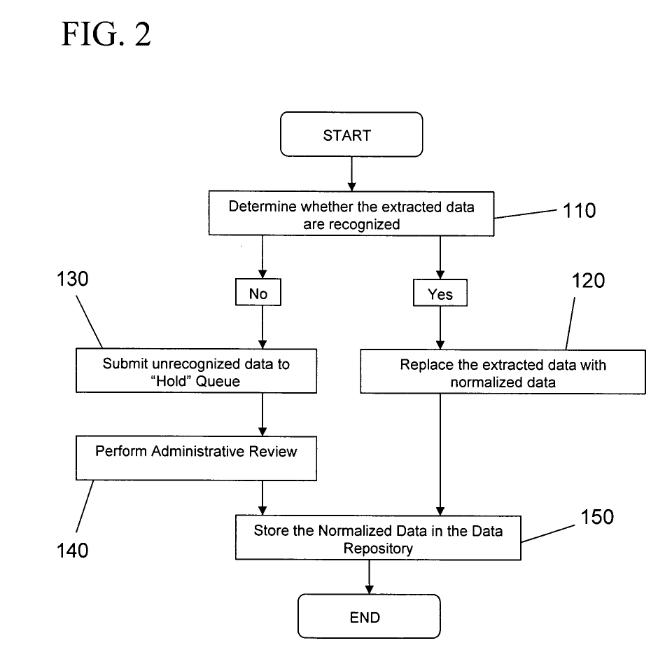

For example, different appraisal reports may represent the same term in different ways. Thus, the term “Above Average” may be represented in a plurality of different ways in different appraisal reports or in different parts of the same appraisal report. For example, “Above Average” may be represented as “Abv Avg,” “Abv. Avg.,” AbvAvg,” “Avg +,” or “Avg+.” Referring now to FIG. 2, an unknown term may be identified 110, such as by comparing the term to a stored compilation of terms (referred to interchangeably as “library of terms”) that have been identified as being equivalent to the term “Above Average.” In one embodiment, once the unknown term is matched with a term in the stored compilation, the originally presented term may be replaced with the common, or normalized, term 120. For example, all terms presented in appraisal reports corresponding to “Above Average” may be normalized into a common term to facilitate subsequent comparison and analysis. In one embodiment, the normalized data may be stored in the data repository 150.

The method of the present invention may include identification of some words, phrases, numbers, or abbreviations that fail to be recognized. The unrecognized information or data may be flagged, so that further review of the information or data may be performed before analysis of the appraisal report continues. For example, further review of the unrecognized information or data may involve review by a person (hereinafter interchangeably referred to as “administrative review”) to determine the meaning of the information or data. In addition, submitted appraisal reports that include unidentified entries may be held in a “hold” queue 130, rather than being released to the guideline engine, discussed in greater detail below, until cleared by an administrative user during administrative review 140, or until a predetermined period has elapsed, for example. If released without administrative review, a warning may be included with the report identifying to the user the fields which were unrecognized. Thus, some words, phrases, numbers, abbreviations, or other extracted information may be accepted or rejected by the system of the present invention and a corresponding notation may be made for inclusion in the evaluation output report.

Once the necessary information and data have been extracted and normalized, the information and data are evaluated by a sophisticated customizable rules guideline engine that, for example, identifies inconsistencies in the appraisal report information.

In one embodiment, a first part of the evaluation may be the static analysis, wherein the system identifies whether the appraisal form was completed in its entirety, such as whether a check box on the appraisal form was or was not checked or marked with an “X.” Additionally, the static check may include attributing information to the subject property that corresponds to the particular check box, and subsequently determining whether that information is consistent or correct with respect to the subject property. Further, the static analysis may include determining whether information entered in one part of the appraisal report matches corresponding information within another area of the report

Another part of the evaluation may include substantive review of the appraisal analysis made by the appraiser for compliance with generally accepted appraisal practices. For example, in the example provided above, the information related to each comparison property may be reviewed to determine whether the comp is appropriate. As detailed above, the subject property may be a 3,000 square foot, three-bedroom, two-bathroom home. However, the appraiser may have used a comp that is only a two-bedroom home. Thus, this home may be identified as not comparable to the subject property, and may make a corresponding notation. Additionally, one or more of the comps may not bracket the subject property. For example, all of the comps may be larger or smaller than 3,000 square feet. Thus, a notation may be made that the comps do not bracket the subject property with respect to square footage.

Also, the guideline engine or other portion of the system may identify any across-the-board adjustments and the corresponding percentage the adjustment represent relative to the value of each comp. An across-the-board adjustment is an adjustment made for each comparative property for any given feature or attribute used for appraising the subject property. For example, one feature used in preparing the appraisal report may include the view from the comparative properties. Each of the comps may have a mountain view, for example, whereas the subject property may not. In this case, the appraiser may assign a value, e.g., $25,000, to the view and may reduce the value of each comp by that amount. However, there may be no basis for assigning $25,000 to the view adjustment. Moreover, the adjustment value may be a significant percentage compared to the entire value of the comps. For example, $25,000 may represent 25% of the value of each comp. Thus, the system of the present invention may identify any across-the-board adjustment exceeding a certain percentage of the value of a comp or an across-the-board adjustment falling within a range percentage of the value of a comp and may make a corresponding notation.

In one embodiment, the notations made may be in the form of a rejection, condition, warning, note, or comment. The type of notation applied to a particular discrepancy or event identified by the guideline engine or other portion of the system is determined by the severity of the discrepancy and may be defined by the user. For example, a rejection may be appropriate when the subject property does not include a heating source. A condition may be applied requiring additional steps before a mortgage loan is approved, such as requiring the appraiser to provide one or more additional comps for comparison or explain the appropriateness of the adjustment value made to a particular comp. Each notation type may include associated text, defined or approved by a user, which is listed on the report if an event triggering a particular rejection, condition, warning, note, or comment occurs. A note may be appropriate for an identified concern having a low associated risk. For example, a note may merely state that a 2% across-the-board adjustment was made in the appraisal report for a particular feature.

One embodiment of the present invention may also include fraud detection functionality. In the situations where appraisal reports are prepared electronically, such as by using available form-fill software, and subsequently outputted as a PDF file, for example, an appraiser may generally add to the appraisal report a copy of the appraiser's original, penned signature. The original signature may be in the form of a signature image file which the form-fill software applies to a specific, designated location in the appraisal report. Consequently, a uniform signature may be consistently added to an appropriate identical location on the appraisal report.

According to one embodiment, the fraud detection functionality is a two-step process. With the use of OCR and OMR techniques, the fraud detection functionality may identify the appraiser's signature included on the appraisal report and may compare the signature with a plurality of signatures contained in a historical database of signatures. Because the appraiser's signature is likely a digital signature, the signature included on the appraisal report should be identical to the appraiser's corresponding signature contained in the historical database of signatures. Therefore, if the signature on the appraisal report matches the signature contained in the signature database, the signature is deemed to be genuine. Thus, the first step of the fraud detection functionality may be detection of a forged signature.

A second step may determine whether the signature is positioned appropriately on the appraisal report. With the use of the form-fill software, the appraiser's signature image file is consistently applied to an identical location for each appraisal report created by the appraiser. Therefore, the fraud detection functionality may determine whether the appraiser's signature is properly aligned on the appraisal report in the exact location as the signature on previous appraisal reports, which are also stored in the historical database of signatures. If the signature is properly located on the appraisal report, the appraisal report may be deemed genuine. Thus, the second step of the fraud detection functionality may detect stolen signatures and, therefore, fraudulent appraisal reports.

Further, the appraiser's signature may appear in multiple locations on the appraisal report, and it is within the scope of the present invention to verify each signature and signature location contained in the appraisal report using the fraud detection functionality techniques.

In one embodiment, after completion of the evaluation by the guideline engine or other portion of the system, the collateral review and analysis system may output an evaluation report. The evaluation report may include a portion summarizing the appraisal analysis performed by the appraiser, and may also enumerate discrepancies, flaws, risks, and/or other concerns associated with the appraisal that were identified by the guideline engine and list the notations (e.g., rejection, condition, warning, note, or comment) accorded to each, as well as a valuation of the subject property. Thus, the evaluation report may include, for example, “low risk,” “moderate risk,” “high risk,” and “very high risk,” concerning the appraisal report being evaluated. The evaluation report may also, for example, be arranged according to a format defined by a user so that all of the high risk items, such as the rejections or conditions, may be listed in the beginning of the evaluation report, and the lower risk items, such as the warnings and notes, may be listed at the end. In one embodiment, the user can select between receiving an evaluation report having a standard or default output, and a customized evaluation report based on user-provided guidelines and trigger rules. Further, the evaluation report may be outputted in PDF format, for example, or in any other electronic format. The evaluation report may also be in the form of an outputted Graphical User Interface (“GUI”) screen, to which an authorized user may add comments or other information, such as specific issue risk scores.

According to a further embodiment, once the evaluation report has been generated, the collateral review and analysis system transmits the evaluation report to the user, e.g., in the form of an attachment to an e-mail, a facsimile, a hard copy, or any other document format. Further, the method and system of the present invention may allow a user to review results of analysis performed by the guideline engine and insert comments associated with, for example, a condition automatically triggered by the present invention. Additionally, the user may waive such a condition and, thus, alter the evaluation report prior to its output and transmittal. Accordingly, it is within the scope of the present invention for the user to manipulate the results received from the guideline engine on an individual appraisal report analysis basis prior to the generation and transmittal of the evaluation report.

According to another embodiment of the present invention, the evaluation results of the guideline engine along with other appraisal data and information extracted and stored in the data repository may be outputted in digital data stream from, such as in extensible Markup Language (“XML”) or other Internet-based format, and may be made available to other end-users, such as Automated Valuation Model (“AVM”) providers that presently use highly unreliable publicly available data. The other end-users may use the digital data stream to offer additional services to the home buyer or lender, such as when certain risks are identified or certain conditions are triggered. For example, if a certain condition is triggered, a third party may offer escalation products (products that may be needed to overcome or address risks associated with the appraisal report, as identified by the guideline engine), up to and including a new appraisal. Thus, in effect, if certain characteristics are triggered by the system for appraisal analysis and review of the present invention, the digital data stream may be forwarded to an AVM, for example, for performance of additional analysis or escalation analysis, or to obtain a new appraisal report.

Another embodiment of the method and system of the present invention includes a statistical analysis tool. For example, the present invention may include functionality to allow a user, such as a lender, to review the analysis results of a group of appraisal reports to identify which appraisal reports triggered, e.g., a particular rejection, condition, warning, note, or comment, or some other predetermined characteristic. Additionally, the present invention may include functionality to identify any variance within the analysis results of a plurality of appraisal reports when compared to an AVM. The appraisal reports indicating a variance may then be subjected to an escalation, e.g., additional evaluation to further scrutinize the data, information, and analysis results associated therewith. Statistical analysis tools, such as third party statistical valuation tools included as part of an AVM, may be used to add additional information to the output report.

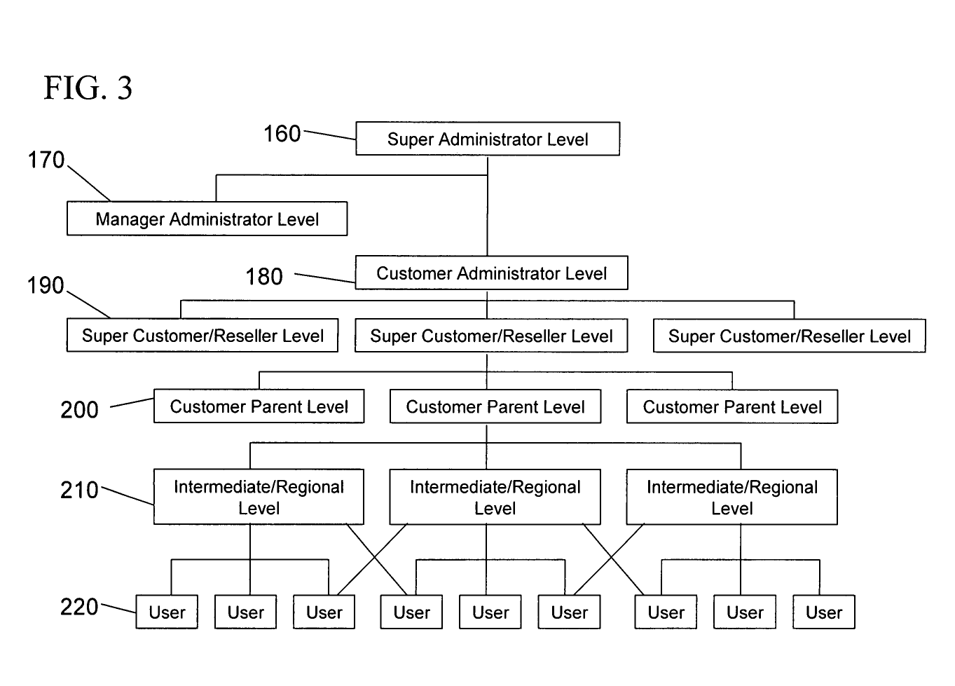

FIG. 3 shows an example hierarchy structure according to an embodiment of the present invention having a plurality of different levels for implementing various administrative functions and having corresponding levels of access and functionality in one system. For fast and easy customization of the present invention, one embodiment may include an administrative system with up to four or more tiers, such as the super administrator level 160, the manager level 170, the customer administrator level 180, and the accounting module (not shown). The super administrator 160 may have the highest level of access to the system and the information therein, may administer the creation of all customer accounts, and may have complete administrative control over all aspects of the system and users thereof, for example. The manager level 170 may be capable of achieving certain authorized modifications and accessing, modifying, adding, and deleting accounts at the customer administrator level, for example. The customer administrator 180 level may have, e.g., the lowest level of access, with limited capabilities, such as making changes to a customer's guidelines. In a further embodiment of the present invention, the customer administrator level 180 may be divided into one or more separate tiers, explained in more detail below.

The tiers of the Customer Administrator level 180 may include, for example, a Super Customer/Reseller level 190; a Customer Parent level 200; an Intermediate/Regional level 210; and User level 220. At least one function of the Super Customer level 190 may be dedicated to tracking and invoicing purposes, such as reviewing appraisal reports submitted and evaluated by users associated with the respective Super Customer/Reseller level 190. A mortgage reseller who has existing end-user customers, for example, may be assigned to Super Customer level 190. One function of Super Customer level 190 may be to conduct invoicing and reporting operations and to track submitted appraisal reports associated with a particular super customer. The next level is Customer Parent level 200, which is the first “customer” level. For example, lenders, such as banks, may be assigned to this level. Some lenders may be large banks having different geographical regions, each of which may have different internal operations in comparison with the other regions, although still a part of the same bank. Thus, each region may require or utilize different guideline rules for evaluating appraisal reports. Accordingly, each of the different regions may be designated as different Intermediate/Regional levels 210 under the bank's Customer Parent level 200. The User level 220 further divides each Intermediate/Regional level 210, and is separated based on each user who submits one or more appraisal reports to or on behalf of the corresponding Intermediate/Regional 210 user, for example.

Each entity, such as a lender, associated with the Intermediate/Regional level 210 may tailor and customize the guideline rules applicable to the appraisal reports submitted by User level 220, consisting of users related to the particular lender.

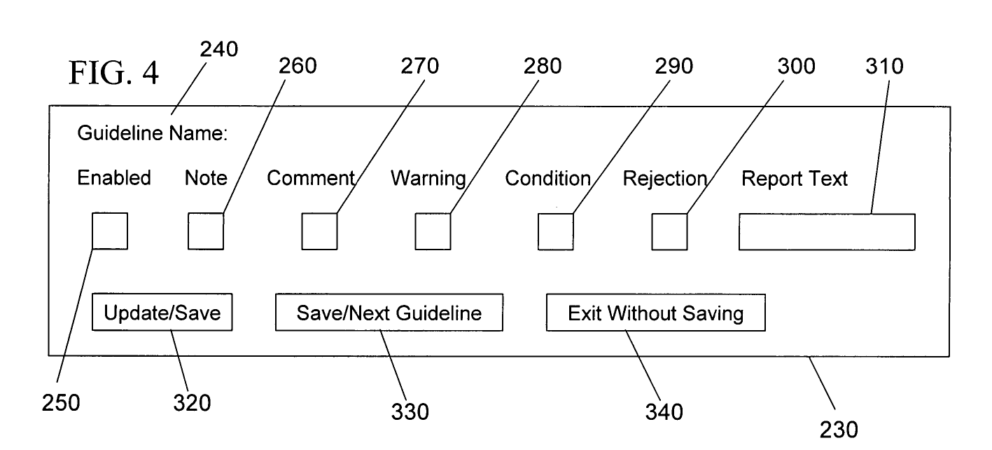

According to one embodiment of the present invention, the guideline rules are defined using a client guideline administration interface, such as a GUI screen. An exemplary GUI screen 230 is represented in FIG. 4. GUI screen 230 may define a single-line guideline rule and may include a name portion 240, an enablement check box 250 for enabling or disabling the guideline rule, and a series of checkboxes 260-300 for triggering one of a Note, Comment, Warning, Condition, or Rejection, respectively, upon an outcome of the evaluation by the guideline rule. Optionally, text may be added in the “Report Text” field 310. The added text may be included in the evaluation report upon completion of the evaluation of the appraisal report if the instant guideline rule is triggered. GUI screen 230 may also include a plurality of control buttons 320 to 340, such as an “Update/Save” button, a “Save/Next Guideline” button, and “Exit Without Saving” button, respectively. The “Update/Save” button 320 saves any changes made to the guideline rule and immediately updates the guideline rule to reflect any changes made. The “Save/Next Guideline” button 330 saves any changes made and advances to the next guideline rule, and the “Exit Without Saving” button 340 exits from the GUI screen 230 without applying any changes made to the guideline rule.

GUI screen 230 may apply, for example, to a guideline rule that is used to evaluate whether a check box of an appraisal report is checked or unchecked. Regardless of whether the check box is checked or unchecked, the guideline rule is triggered causing one of a rejection, condition, warning, comment, or note, along with any text added in “Report Text” field 310, to be presented as part of the evaluation report.

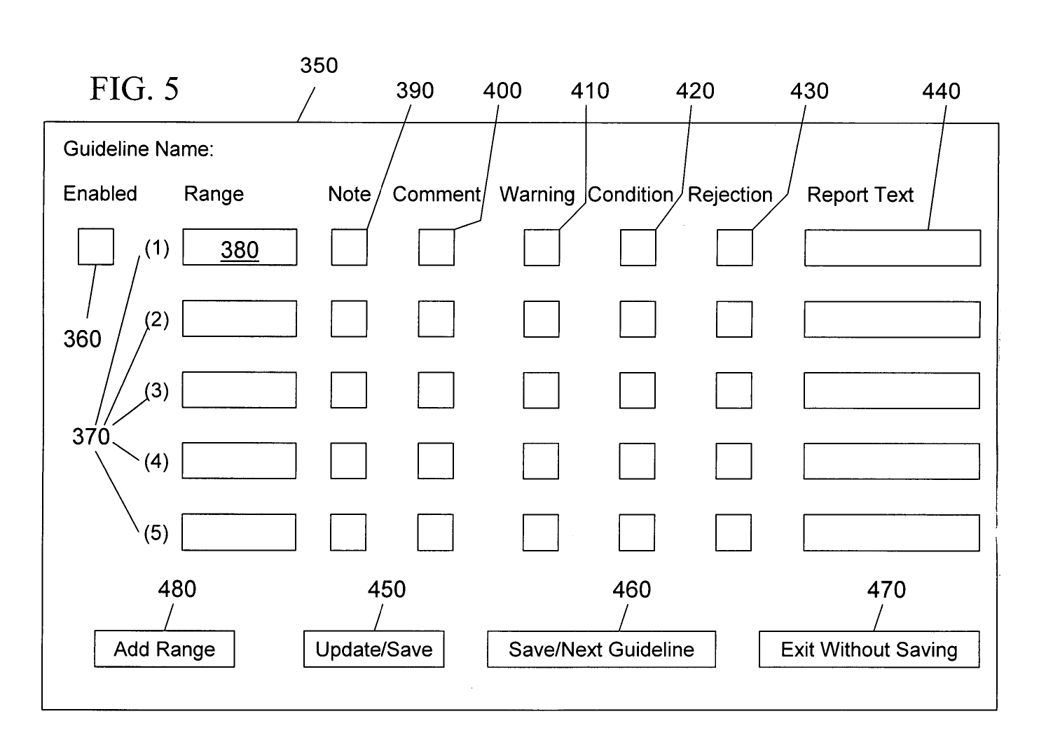

FIG. 5 illustrates an exemplary GUI screen 350 for a multiple-line guideline rule. A guideline rule defined using an example GUI screen 350 is capable of evaluating, for example, whether a value extracted from the appraisal report exceeds a predefined value and, if so, is capable of triggering a notation according to the amount by which the extracted value exceeds the predetermined value. For. example, a multiple-line guideline rule may be defined to evaluate whether an adjustment to a property value equals or exceeds a percentage of the value of the comparable property. Moreover, the multiple-line guideline rule may provide multiple evaluations for an adjustment and different outputs, depending upon the percentage value of the comparable property the adjustment represents. Thus, GUI screen 350 may include an enabled button 360 and individual rows 370 for defining different evaluation operations. It is within the scope of the present invention to include any number of evaluation rows 370. Each evaluation row 370 may include, for example, a “Range” field 380, a “Note” checkbox 390, a “Comment” checkbox 400, a “Warning” checkbox 410, a “Condition” checkbox 420, and a “Rejection” checkbox 430. A user may enter a percentage range in the “Range” field 380 and may select one of the checkboxes 390 to 430 that is to be triggered if an adjustment, for example, falls within the percentage range. Optionally, the user may also enter text in “Report Text” field 440 that is to be presented on the evaluation report.

Continuing the above example, a different percentage range may be included in the “Range” field 380 in each different row 370 potentially causing a different notation and, optionally, a corresponding text string to be included on the evaluation report. For example, the “Range” field 380 in the first row 370 may include 5 to 10%, 10 to 15% in the second row 370, 15 to 20% in the third row 370, and so on. Thus, the multiple-line guideline is capable of altering a result of an evaluation, thereby depending upon the magnitude of the data being evaluated.

GUI screen 350 may also include an “Update/Save” button 450, a “Save/Next Guideline” button 460, and an “Exit Without Saving” button 470, each functioning in the manner described above, as well as an “Add Range” button 480. The “Add Range” button 480 adds additional rows 370 for additional levels of evaluation to be performed by the guideline rule.

According to a further embodiment, each Intermediate/Regional level user may also designate e-mail addresses (e.g., e-mail addresses having a specific e-mail domain) of users at the user level 220 who are authorized to submit appraisal reports on behalf of the particular Intermediate/Regional level 210 user. Consequently, only users submitting an appraisal report in a properly designated e-mail may be permitted. Alternatively, if a User level 220 user submits an appraisal report in an e-mail having a non-designated e-mail address, the appraisal report may not be accepted. Moreover, according to another embodiment of the present invention, a User level 220 user who submits an appraisal report using a designated e-mail address may automatically be added as a user of that Intermediate/Regional level 210 user. Therefore, one user may be a User level user for multiple Intermediate/Regional level 210 users.

In a further embodiment, the collateral review and analysis system may include functionality such that a User level 220 user may review all information relating to submissions made, even where the submissions are made to different Intermediate/Regional level 210 users. Additionally, each Intermediate/Regional level 210 user may review all information relating to submissions made by the User level 220 users associated therewith. However, each Intermediate/Regional level 210 user may not be permitted to review information relating to submissions made by the User level 220 users that are submitted to a different Intermediate/Regional level 210 user. Each Customer Parent level 200 user may review all information relating to the submission corresponding to each related Intermediate/Regional level 210 user, and each Super Customer level 190 user may review all submissions corresponding to each related Customer Parent level 200 user. Thus, a particular user may be limited, for example, to accessing information, reports, and analyses associated with a particular authorized set of e-mail addresses.

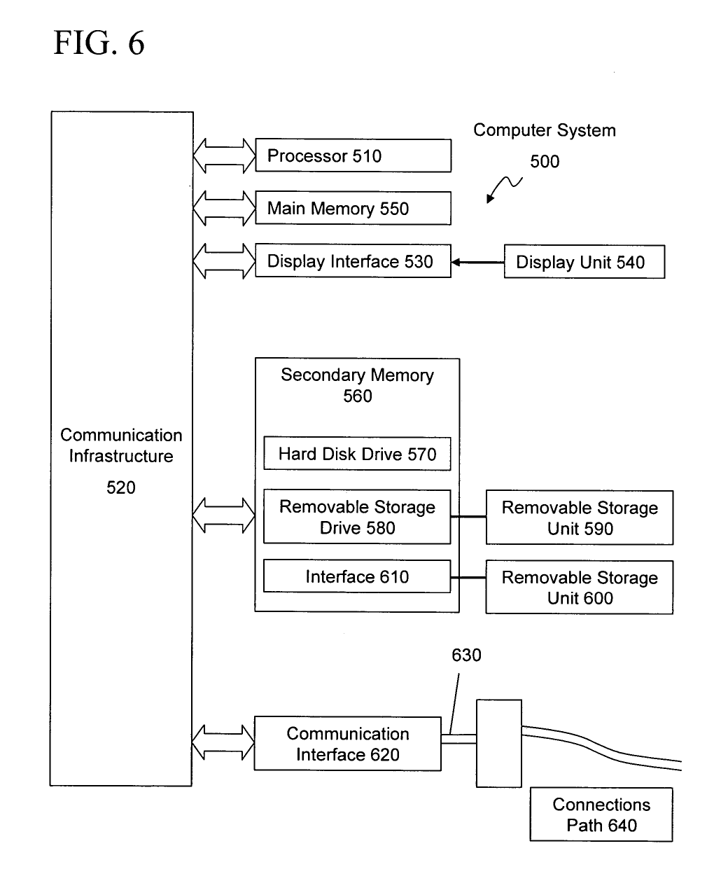

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system 500 is shown in FIG. 6.

Computer system 500 includes one or more processors, such as processor 510. The processor 510 is connected to a communication infrastructure 520 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 530 that forwards graphics, text, and other data from the communication infrastructure 520 (or from a frame buffer not shown) for display on a display unit 540. Computer system 500 also includes a main memory 550, preferably random access memory (RAM), and may also include a secondary memory 560. The secondary memory 560 may include, for example, a hard disk drive 570 and/or a removable storage drive 580, representing a floppy disk drive, a magnetic tape drive, an optical disk drive, etc. The removable storage drive 580 reads from and/or writes to a removable storage unit 590 in a well known manner. Removable storage unit 590, represents a floppy disk, magnetic tape, optical disk, etc., which is read by and written to removable storage drive 580. As will be appreciated, the removable storage unit 590 includes a computer usable storage medium having stored therein computer software and/or data.

In alternative embodiments, secondary memory 560 may include other similar devices for allowing computer programs or other instructions to be loaded into computer system 500. Such devices may include, for example, a removable storage unit 600 and an interface 610. Examples of such may include a program cartridge and cartridge interface (such as that found in video game devices), a removable memory chip (such as an erasable programmable read only memory (EPROM), or programmable read only memory (PROM)) and associated socket, and other removable storage units 600 and interfaces 610, which allow software and data to be transferred from the removable storage unit 600 to computer system 500.

Computer system 500 may also include a communications interface 620. Communications interface 620 allows software and data to be transferred between computer system 500 and external devices. Examples of communications interface 620 may include a modem, a network interface (such as an Ethernet card), a communications port, a Personal Computer Memory Card International Association (PCMCIA) slot and card, etc. Software and data transferred via communications interface 620 are in the form of signals 630, which may be electronic, electromagnetic, optical or other signals capable of being received by communications interface 620. These signals 630 are provided to communications interface 620 via a communications path (e.g., channel) 640. This path 640 carries signals 630 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 580, a hard disk installed in hard disk drive 570, and signals 630. These computer program products provide software to the computer system 500. The invention is directed to such computer program products.

Computer programs (also referred to as computer control logic) are stored in main memory 550 and/or secondary memory 560. Computer programs may also be received via communications interface 620. Such computer programs, when executed, enable the computer system 500 to perform the features of the present invention, as discussed herein. In particular, the computer programs, when executed, enable the processor 510 to perform the features of the present invention. Accordingly, such computer programs represent controllers of the computer system 500.

In an embodiment where the invention is implemented using software, the software may be stored in a computer program product and loaded into computer system 500 using removable storage drive 580, hard drive 570, or communications interface 620. The control logic (software), when executed by the processor 510, causes the processor 510 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

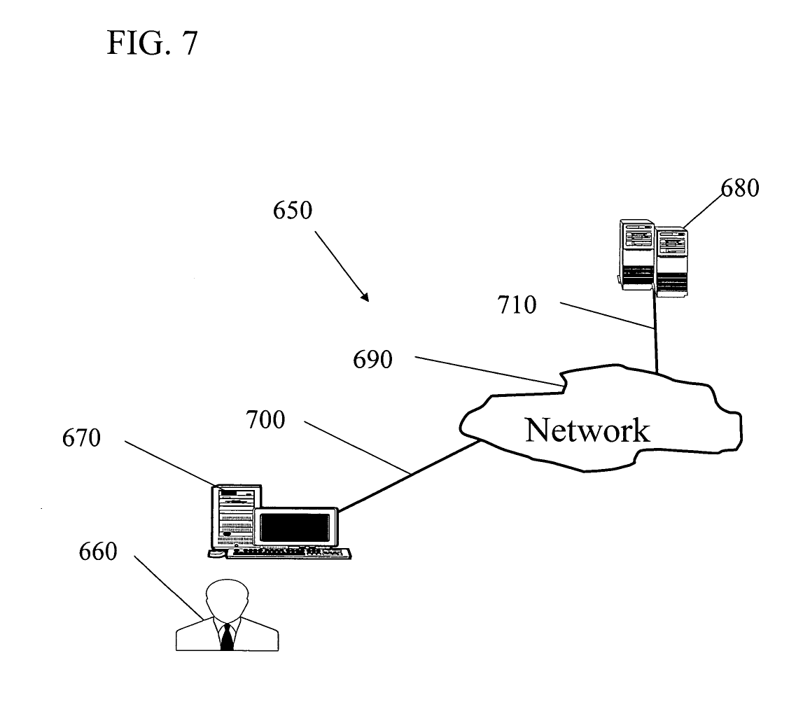

FIG. 7 shows a communication system 650 usable in accordance with the present invention. The communication system 650 includes an accessor 660 (also referred to interchangeably herein as a “user”) and a terminal 670. In one embodiment, data for use in accordance with the present invention is, for example, input and/or accessed by the accessor 660 via the terminal 670, such as a personal computer (PC), minicomputer, mainframe computer, microcomputer, telephonic device, or wireless device, such as a personal digital assistant (“PDA”) or a hand-held wireless device coupled to a server 680, such as a PC, minicomputer, mainframe computer, microcomputer, or other device having a processor and a repository for data and/or connection to a processor and/or repository for data, via, for example, a network 690, such as the Internet or an intranet, and couplings 700, 710. The couplings 700, 710 include, for example, wired, wireless, or fiberoptic links. In another embodiment, the method and system of the present invention operate in a stand-alone environment, such as on a single terminal.

Additional advantages and novel features of the invention will be set forth in part in the description that follows, and in part will become more apparent to those skilled in the art upon examination of the following or upon learning by practice of the invention.

What is claimed is:

1. A method for reviewing and evaluating an appraisal report, the method comprising:
identifying an appraisal report;
identifying relevant data contained in the appraisal report;
extracting the relevant data;
storing the extracted data in a data repository;
normalizing at least a portion of the extracted data;
applying one or more decision rules to the normalized data to identify one or more predetermined events; and
generating an evaluation report including an outcome of the one or more decision rules.

2. The method according to claim 1, wherein normalizing the extracted data further comprises:
comparing one or more of the extracted data with known values;
determining whether the one or more extracted data match the known values; and
isolating the relevant data extracted from the appraisal report when the one or more extracted data does not match the known values.

3. The method according to claim 2, wherein normalizing at least a portion of the extracted data further comprises:
substituting the one or more extracted data with a known value corresponding to the recognized extracted data.

4. The method according to claim 1, wherein identifying the appraisal form is performed using one of optical character recognition and optical mark recognition techniques.

5. The method according to claim 1, wherein identifying relevant data contained in the appraisal form is performed using one of optical character recognition and optical mark recognition techniques.

6. The method according to claim 1, further comprising:
generating one or more notations upon a predetermined outcome of the one or more decision rules.

7. The method according to claim 6, wherein the one or more notations comprise at least one of a group consisting of a rejection, a condition, a warning, a note, and a comment.

8. The method according to claim 1, wherein the appraisal report is an appraisal report for residential real property.

9. The method according to claim 1, further comprising:
determining fraud in the appraisal report.

10. The method according to claim 9, wherein determining fraud in the appraisal report comprises:
extracting a signature from the appraisal report;
identifying the location of the signature on the appraisal report; and
determining whether the signature is a genuine signature.

11. The method according to claim 10, wherein the step of determining whether the signature is a genuine signature further comprises:
comparing the signature to at least one known signature;
comparing the location of the signature to a known signature location.

12. The method according to claim 1, wherein applying one or more decision rules to the normalized data to identify one or more predetermined events further comprises:
applying customizable rules for analyzing the normalized data.

13. The method according to claim 12, wherein applying customizable rules for analyzing the normalized data comprises:
comparing at least one data element of the normalized data to another data element.

14. The method according to claim 12, applying customizable rules for analyzing the normalized data comprises:
comparing at least one data element of the normalized data to a numerical value.

15. A system for reviewing and evaluating an appraisal report, the system comprising:
means for identifying an appraisal report;
means for identifying relevant data contained in the appraisal report;
means for extracting the relevant data;
means for storing the extracted data in a data repository;
means for normalizing at least a portion of the extracted data;
means for applying one or more decision rules to the normalized data to identify one or more predetermined events; and
means for generating an evaluation report including an outcome of the one or more decision rules.

16. A system for reviewing and evaluating an appraisal report, the system comprising:
a processor;
a user interface functioning via the processor; and
a repository accessible by the processor,
wherein an appraisal report is identified,
wherein relevant data contained in the appraisal report is identified,
wherein the relevant data is extracted,
wherein the extracted data is stored in the data repository,
wherein at least a portion of the extracted data is normalized,
wherein one or more decision rules are applied to the normalized data to identify one or more predetermined events, and
wherein an evaluation report is generated including an outcome of the one or more decision rules.

17. The system according to claim 16, wherein the processor is housed on a terminal.

18. The system according to claim 16, wherein the terminal is selected from a group consisting of a personal computer, a minicomputer, a main frame computer, a microcomputer, a hand-held device, and a telephonic device.

19. The system according to claim 16, wherein the processor is housed on a server.

20. The system according to claim 19, wherein the server is selected from a group consisting of a personal computer, a minicomputer, a microcomputer, and a main frame computer.

21. The system according to claim 19, wherein the server is coupled to a network.

22. The system according to claim 21, wherein the network is the Internet.

23. The system according to claim 21, wherein the server is coupled to the network via a coupling.

24. The system according to claim 23, wherein the coupling is selected from a group consisting of a wired connection, a wireless connection, and a fiberoptic connection.

25. The system according to claim 16, wherein the repository is housed on a server.

26. The system according to claim 25, wherein the server is coupled to a network.

27. A computer program product comprising a computer usable medium having control logic stored therein for causing a computer to review and evaluate an appraisal report, the control logic comprising:
first computer readable program code means for identifying an appraisal report;
second computer readable program code means for identifying relevant data contained in the appraisal report;
third computer readable program code means for extracting the relevant data;
fourth computer readable program code means for storing the extracted data in a data repository;
fifth computer readable program code means for normalizing at least a portion of the extracted data;
sixth computer readable program code means for applying one or more decision rules to the normalized data to identify one or more predetermined events; and
seventh computer readable program code means for generating an evaluation report including an outcome of the one or more decision rules.

28. The computer program product according to claim 27, the fifth computer readable program code means for normalizing at least a portion of the extracted data comprising:
eighth computer readable program code means for comparing one or more of the extracted data with known values;
ninth computer readable program code means for recognizing the one or more extracted data when the one or more extracted data matches the known values; and
tenth computer readable program code means for isolating the relevant data extracted from the appraisal report when the one or more extracted data does not match the known values.
